(19) United States
(12) Patent Application Publication
(10) Pub. No.: US 2010/0229452 A1
(43) Pub. Date: Sep. 16, 2010

(54) FIREARM SYSTEM HAVING CAMERA UNIT WITH ADJUSTABLE OPTICAL AXIS

(75) Inventor: Bong-kyung SUK, Changwon-city (KR)

Correspondence Address: SUGHRUE MION, PLLC, 2100 PENNSYLVANIA AVENUE, N.W., SUITE 800, WASHINGTON, DC, 20037, US

(73) Assignee: Samsung Techwin Co., Ltd., Changwon-city (KR)

(21) Appl. No.: 12/578,944

(22) Filed: Oct. 14, 2009

(30) Foreign Application Priority Data
Mar. 12, 2009 (KR) 10-2009-0021295

(51) Int. Cl. F41G 1/00; H04N 5/225

(52) U.S. Cl. 42/146; 348/375; 348/E05.024

(57) ABSTRACT

A firearm system having a camera unit with an adjustable optical axis includes a firing device having a muzzle and a light beam projection unit adjusted to an axis of the muzzle and projecting a light beam, a camera unit arranged at a side of the firing device, and an optical axis adjustment unit supporting the camera unit and rotating the camera unit around at least one of a first rotation axis and a second rotation axis perpendicular to the first rotation axis to adjust the optical axis of the camera unit to the light beam of the light beam projection unit on an image obtained by the camera unit.

### CROSS-REFERENCE TO RELATED PATENT APPLICATIONS

This application claims priority from Korean Patent Application No. 10-2009-0021295, filed on Mar. 12, 2009, in the Korean Intellectual Property Office, the disclosure of which is incorporated herein in its entirety by reference.

### BACKGROUND OF THE INVENTION

1. Field of the Invention

Apparatuses consistent with the present invention relate to a firearm system having a camera unit with an adjustable optical axis, and more particularly, to a firearm system having a camera unit with an optical axis that is easily and precisely adjustable, and an optical adjustment apparatus that supports the camera unit to be capable of rotating around a first rotation axis and a second rotation axis.

2. Description of the Related Art

Intelligent security robots monitor an extensive area, detect and, if necessary, track an object meeting particular conditions, get an enemy intruder by firing, and are connected to a central control system in a wired or wireless manner to be remotely controlled. The security robot is equipped with a firing device for performing a fire function. A camera unit for obtaining an image of a target for firing is installed on the firing device.

For precise firing by the firing device, the camera unit needs to precisely obtain an image of a firing target. Accordingly, the optical axis of the camera unit is precisely adjusted to the central axis of the muzzle of the firing device.

In general, a plurality of long bolt holes for adjustment of the optical axis of the camera unit are formed in an installation portion of the firing device where the camera unit is installed. In order to install the camera unit on the firing device, a bullet is projected using the firing device, and subsequently, to match the impact point of the projected bullet with the central axis of an image generated by the camera unit, the camera unit is slightly rotated using the long bolt holes formed in the installation portion, or the optical axis of the camera unit is finely adjusted by inserting a shim formed of a thin metal plate in the installation portion in order to finely adjust the optical axis of the camera unit. However, the above methods are inefficient, inconvenient and dangerous to use to finely adjust the optical axis of the camera unit to the muzzle of the firing device.

However, the camera unit optical axis adjustment is still needed not only to initially install the firing device, but also to correct an error generated due to vibrations of firing, or repair after long use of the firing device. Thus, there is a demand for development of technology to conveniently and precisely adjust the optical axis of the camera unit.

To adjust the optical axis of the camera unit installed on the firing device, a driving unit such as a servo motor or a step motor to rotate the camera unit with respect to the firing device may be taken into consideration. However, the use of the driving unit may increase the volume of a system or make the structure of the system complicated.

### SUMMARY OF THE INVENTION

To address the above and/or other issues, the present invention provides that the optical axis of a camera unit installed on a firing device may be conveniently and precisely adjusted.

The present invention provides a firearm system having a camera unit with an adjustable optical axis so that the optical axis of the camera unit may be conveniently adjusted with a compact structure.

According to an aspect of the present invention, a firearm system having a camera unit with an adjustable optical axis includes a firing device having a muzzle and a light beam projection unit adjusted to an axis of the muzzle and projecting a light beam, a camera unit arranged at a side of the firing device, and an optical axis adjustment unit supporting the camera unit and rotating the camera unit around each of a first rotation axis and a second rotation axis crossing the first rotation axis to adjust the optical axis of the camera unit to the light beam of the light beam projection unit on an image obtained by the camera unit.

The optical axis adjustment mechanism may include a first rotation portion having a first worm gear and a first rotation plate, the first rotation plate having a first gear surface formed on a circumferential surface thereof and coupled to the first worm gear and rotating around the first rotation axis, and a second rotation portion installed on the first rotation plate to rotate around the second rotation axis and supporting the camera unit.

The second rotation portion may include a bottom plate coupled to the first rotation plate and having a concave circular arc surface formed on a surface opposite to the first rotation plate, a movable plate having one surface contacting the bottom plate, on which a convex circular arc surface is formed corresponding to the concave circular arc surface of the bottom plate, and the other surface coupled to the camera unit, and a second worm gear coupled to a second gear surface that is formed on the convex circular arc surface, wherein, when the second worm gear rotates, the movable plate is rotated along the concave circular arc surface of the bottom plate.

The second rotation portion may include a vertical support plate coupled to the first rotation plate, a second rotation plate rotatably coupled to the vertical support plate to rotate around the second rotation axis, and having a second gear surface formed on a circumferential surface thereof, and a second worm gear rotating by being engaged with the second gear surface of the second rotation plate.

The optical axis adjustment mechanism may include a first rotation portion comprising a first bottom plate having a first concave circular arc surface on a surface thereof, a first movable plate having a first convex circular arc surface corresponding to the first concave circular arc surface, coupled to the first bottom plate, and rotating around the first rotation shaft, and a first worm gear coupled to a first gear surface formed on the first convex circular arc surface, and a second rotation portion installed on the first movable plate to rotate around the second rotation axis and supporting the camera unit.

The second rotation portion may include a second bottom plate coupled to the first movable plate and having a second concave circular arc surface formed on a surface opposite to the first movable plate, a second movable plate having one surface contacting the second bottom plate, on which a second convex circular arc surface is formed corresponding to the concave circular arc surface of the second bottom plate, and the other surface coupled to the camera unit, and a second worm gear coupled to a second gear surface that is formed on the second convex circular arc surface, wherein, when the second worm gear rotates, the second movable plate is rotated along the second concave circular arc surface of the second bottom plate.

The second rotation portion may include a vertical support plate coupled to the first rotation plate, a rotation plate rotatably coupled to the vertical support plate to rotate around the second rotation axis, and having a second gear surface formed on a circumferential surface thereof, and a second worm gear rotating by being engaged with the second gear surface of the rotation plate.

The firearm system may further include a first motor coupled to the first worm gear and transferring a driving force, and a second motor coupled to the second worm gear and transferring the driving force.

The firearm system may further include a controller connected to the camera unit, the first motor, and the second motor, recognizing a position of a light beam projected by the light beam projection unit on an image obtained by the camera unit, and generating a control signal controlling the first motor and the second motor to adjust the optical axis of the camera unit to the position of the light beam.

The firearm system may further include a stopper limiting the rotation of the camera unit by the first rotation portion and the second rotation portion.

### BRIEF DESCRIPTION OF THE DRAWINGS

The above and other aspects of the present invention will become more apparent by describing in detail exemplary embodiments thereof with reference to the attached drawings, in which:

FIG. 1A is a perspective view of a firearm system having a camera unit with an adjustable optical axis, and FIG. 1B is a block diagram of the firearm system of FIG. 1A, according to an exemplary embodiment of the present invention;

FIG. 2 illustrates the coupling relationship between the camera unit and the optical adjustment apparatus of the firearm system of FIG. 1, according to an exemplary embodiment of the present invention;

FIG. 3 is a perspective view of the first rotation portion of the optical axis adjustment mechanism of FIG. 2, according to an exemplary embodiment of the present invention;

FIG. 4 is a perspective view of the second rotation portion of the optical axis adjustment mechanism of FIG. 2, according to an exemplary embodiment of the present invention;

FIG. 5 is an exploded perspective view illustrating the structure of the first rotation portion of FIG. 3, according to an exemplary embodiment of the present invention;

FIG. 6 is an exploded perspective view illustrating the structure of the second rotation portion of FIG. 3, according to an exemplary embodiment of the present invention;

FIG. 7 illustrates the operation of adjusting the optical axis of the camera unit in the firearm system of FIG. 1, according to an exemplary embodiment of the present invention;

FIG. 8 illustrates the state in which the optical axis of the camera unit of FIG. 7 is adjusted, according to an exemplary embodiment of the present invention; and

FIG. 9 is a perspective view of an assembly of the camera unit and the optical axis adjustment mechanism in a firearm system having a camera unit with an adjustable optical axis according to another exemplary embodiment of the present invention.

### DETAILED DESCRIPTION OF EXEMPLARY EMBODIMENTS

The attached drawings for illustrating exemplary embodiments of the present invention are referred to in order to gain a sufficient understanding of the present invention, the merits thereof, and the objectives accomplished by the implementation of the present invention. Hereinafter, the present invention will be described in detail by explaining exemplary embodiments of the invention with reference to the attached drawings. Like reference numerals in the drawings denote like elements.

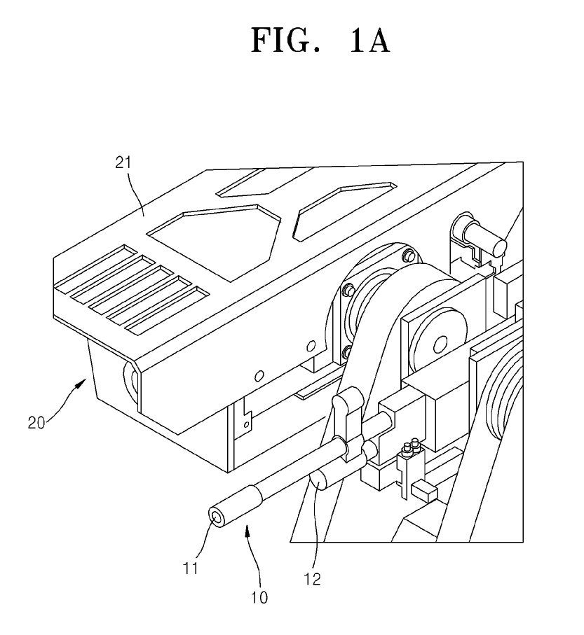

FIG. 1A is a perspective view of a firearm system having a camera unit with an adjustable optical axis according to an exemplary embodiment of the present invention. Referring to FIG. 1A, the firearm system includes a firing device 10 having a muzzle 11 from which a bullet is projected, and a camera unit 20 arranged at the side of the firing device 10. The firing device 10 includes a light beam projection unit 12. The light beam projection unit 12 projects a linear light beam such as a laser beam in alignment with the central axis of the muzzle 11 to indicate a fire target of the firing device 10.

The camera unit 20 obtains an image of the fire target of the firing device 10. The camera unit 20 is accommodated in a camera housing 21 that is fixed to the side surface of the firing device 10.

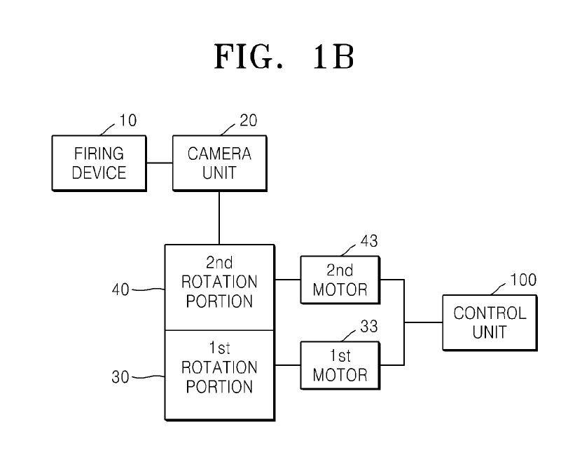

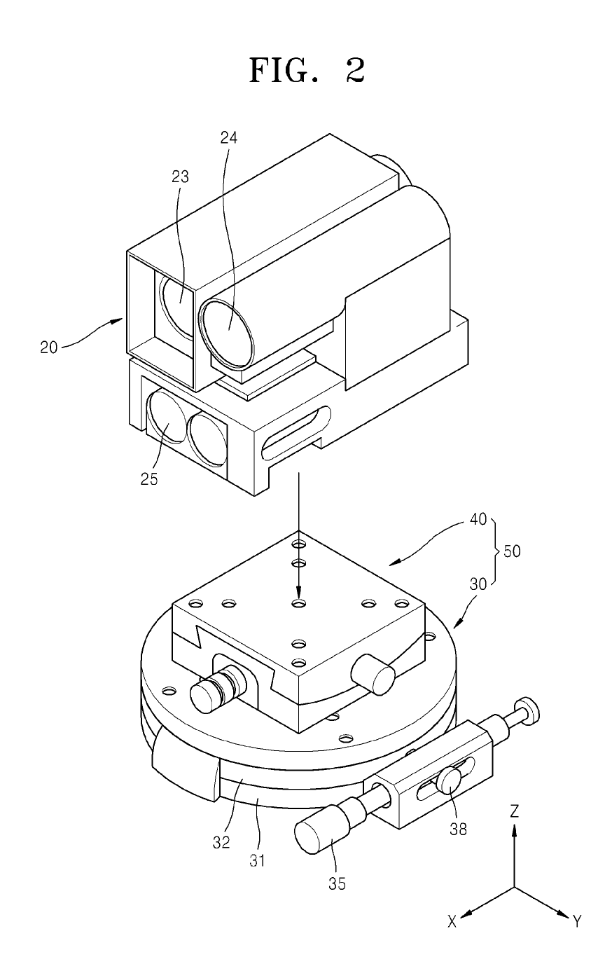

FIG. 2 illustrates for explaining the coupling relationship between the camera unit 20 and an optical adjustment unit of the firearm system of FIG. 1A. Referring to FIG. 2, the camera unit 20 and the optical axis adjustment unit 50 are accommodated in the camera housing 21 of FIG. 1A. A support portion 31 of the optical axis adjustment unit 50 is fixed to the camera housing 21 to rotatably support the camera unit 20.

The camera unit 20 may include a plurality of camera modules 23, 24, and 25 to obtain images for various purposes. The optical axis adjustment unit 50 may rotate the camera unit 20 around a first rotation axis which is parallel to Z axis as shown in FIG. 2 and a second rotation axis which is parallel to Y axis that crosses the first rotation axis. Thus, the optical axis adjustment unit 50 may adjust the optical axis of the camera unit 20 to the light beam of the light beam projection unit 12 on an image photographed by the camera unit 20.

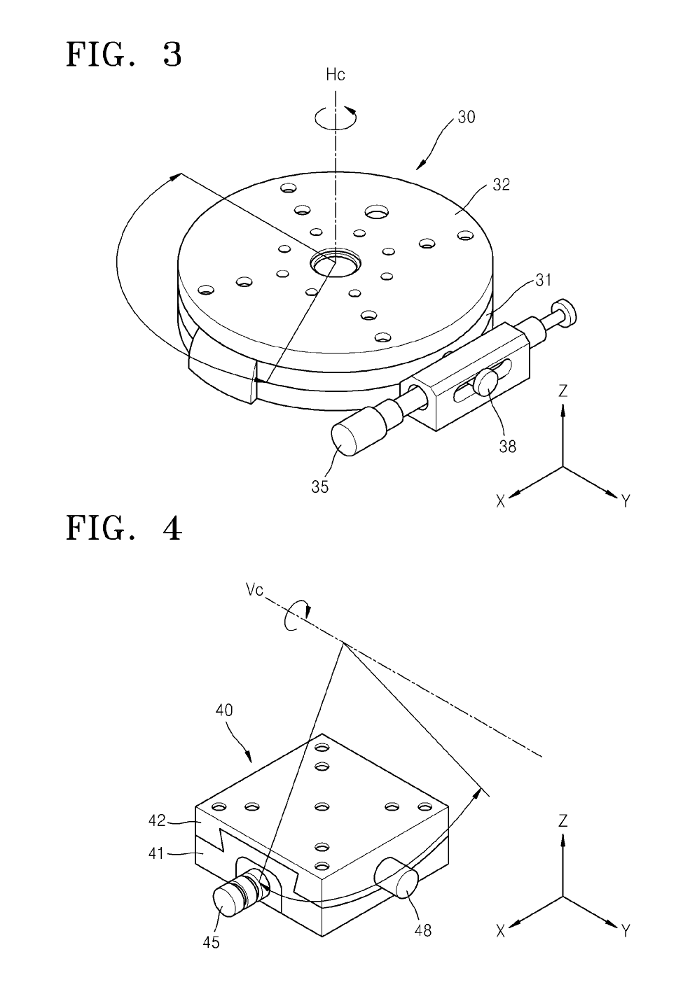

FIG. 3 is a perspective view of a first rotation portion 30 of the optical axis adjustment unit 50 of FIG. 2. FIG. 4 is a perspective view of a second rotation portion 40 of the optical axis adjustment unit 50 of FIG. 2. The optical axis adjustment unit 50 includes the first rotation portion 30 and the second rotation portion 40.

Referring to FIG. 3, the first rotation portion 30 includes a first rotation plate 32 rotating around a first rotation axis Hc that is parallel to the Z axis, the support portion 31 rotatably supporting the first rotation plate 32, an angle adjustment portion 35 fixed to the support portion 31 and transferring a rotational force to the first rotation plate 32, and a stopper 38 fixing the first rotation plate 32 at a predetermined position. Thus, the first rotation portion 30 may rotate the camera unit 20 along the first rotation axis Hc.

Referring to FIG. 4, the second rotation portion 40 includes a movable plate 42 rotating around a second rotation axis Vc that is parallel to the Y axis and a bottom plate 41 coupled to the first rotation portion 30 and rotatably supporting the movable plate 42. An angle adjustment portion 45 transferring a rotational force to the movable plate 42 and a stopper 48 fixing the movable plate 42 at a particular position are installed on the bottom plate 41. Thus, the second rotation portion 40 may rotate the camera unit 20 along the second rotation axis Vc.

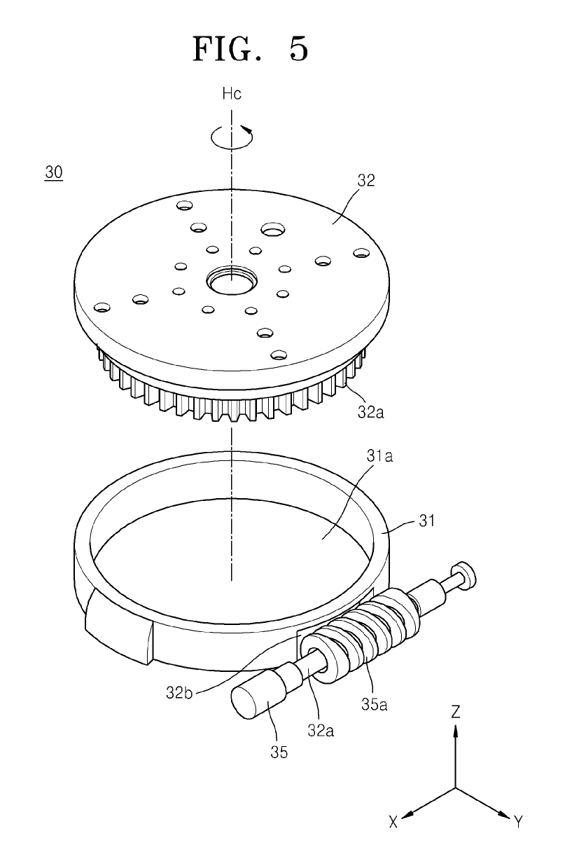

FIG. 5 is an exploded perspective view illustrating a structure of the first rotation portion 30 of FIG. 3. Referring to FIG. 5, a first gear surface 32a is formed on a circumferential surface of the first rotation plate 32 of the first rotation portion 30. The first gear surface 32a of the first rotation plate 32 is inserted in an installation portion 31a of the support portion 31 so that the first rotation plate 32 may be rotated with respect to the support portion 31. A first worm gear 35a is formed on an axis of the angle adjustment portion 35 which is disposed outside the support portion. The first worm gear 35a and the first gear surface 32a, inserted in the installation portion 31a of the support portion 31, are coupled to each other through a through hole 32b formed in the support portion 31. Thus, when a user rotates the angle adjustment portion 35, the first worm gear 35a rotates so that a rotational force may be transferred to the first gear surface 32a.

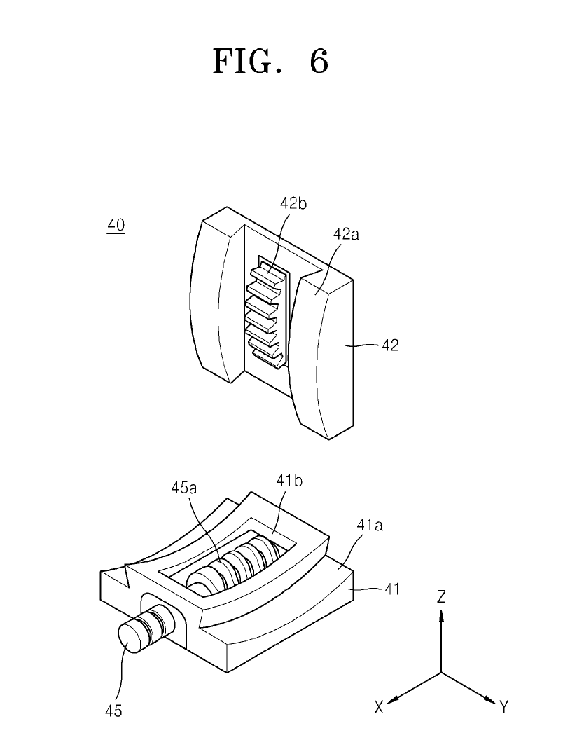

FIG. 6 is an exploded perspective view illustrating a structure of the second rotation portion 40 of FIG. 3. Referring to FIG. 6, the second rotation portion 40 includes a bottom plate 41 coupled to the first rotation plate 32, a movable plate 42 movably coupled to the bottom plate 41, and a second worm gear 45a. A concave circular arc surface 41a is formed on a surface of the bottom plate 41, which is opposite to the first rotation plate 32.

A convex circular arc surface 42a is formed on a surface of the movable plate 42, corresponding to the concave circular arc surface 41a. The camera unit 20 may be coupled to the surface of the movable plate 42 that is opposite to the convex circular arc surface 42a. A second gear surface 42b is formed along the convex circular arc surface 42a.

The second worm gear 45a is formed on an axis of the angle adjustment portion 45 that is rotatably coupled to the bottom plate 41. Since the second gear surface 42b of the movable plate 42 is coupled to the second worm gear 45a through a through hole 41b of the bottom plate 41, as the second worm gear 45a rotates, a rotational force is transferred to the second gear surface 42b of the bottom plate 41. Thus, the movable plate 42 moves along the concave circular arc surface 41a of the bottom plate 41, rotating around the second rotation axis Vc as shown in FIG. 4.

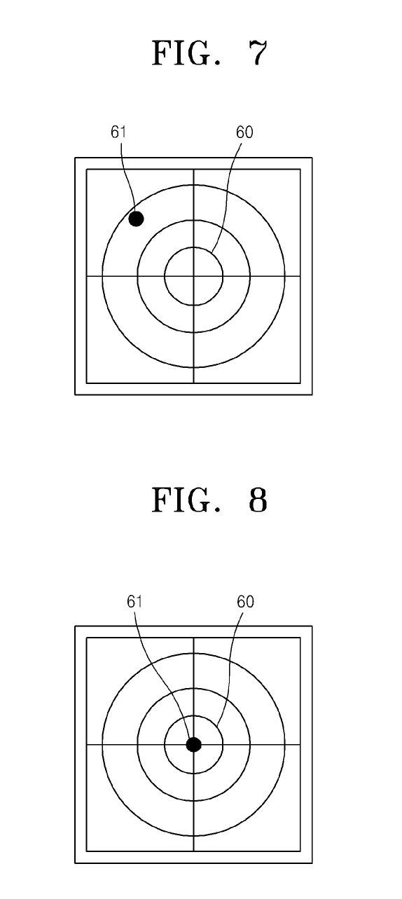

FIG. 7 illustrates an operation of adjusting the optical axis of the camera unit 20 in the firearm system of FIG. 1A. FIG. 8 illustrates a state in which the optical axis of the camera unit 20 of FIG. 7 is adjusted. FIGS. 7 and 8 illustrate images photographed by the camera unit 20 of FIG. 1A.

The image of FIG. 7 shows that a focus 61 of a light beam projected by the light beam projection unit 12 is deviated from a central area 60 of the optical axis of the camera unit 20. An operator adjusting the firearm system may rotate the camera unit 20 by finely adjusting the first and second rotation portions 30 and 40 of the optical axis adjustment unit 50 while monitoring the image. Accordingly, by adjusting the optical axis of the camera unit 20, the focus 61 of the light beam projected by the light beam projection unit 12 may be precisely and conveniently adjusted to the central area 60 of the optical axis of the camera unit, as illustrated in FIG. 8.

Also, in the above-described exemplary embodiments, as the operator manually operates the angle adjustment portion 35 or 45, the first and second rotation portions 30 and 40 of the optical axis adjustment unit 50 are rotated, but the present invention is not limited thereto. For example, the optical axis adjustment function of the camera unit 20 may be performed by respectively connecting a first motor 33 and a second motor 43 (as shown in FIG. 1B) to the first rotation portion 30 (specifically to the angle adjustment portion 35) of FIG. 3 and the second rotation portion 40 (specifically to the angle adjustment portion 45) of FIG. 4, and operating the first and second motors.

Also, a control unit 100 of the firearm system, as shown in FIG. 1B), may have a function to generate a control signal for automatically controlling the first and second motors by recognizing the position of the light beam projected by the light beam projection unit 12 on the image of the camera unit 20. When the firearm system is provided with the control unit having the above function, the optical axis of the camera unit 20 may be automatically adjusted without rotating the first and second rotation portions 30 and 40 by a user. Thus, when an error is generated in the optical axis of the camera unit 20 in actual fighting using the firearm system, the error may be actively addressed.

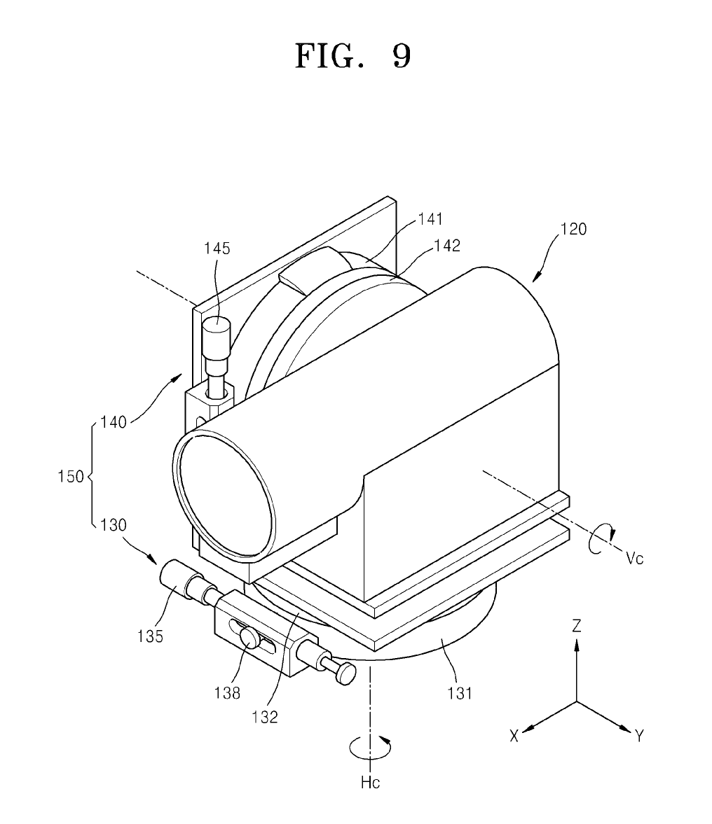

FIG. 9 is a perspective view of an assembly of a camera unit 120 and an optical axis adjustment unit 150 in a firearm system having a camera unit 120 with an adjustable optical axis according to another exemplary embodiment of the present invention. Referring to FIG. 9, the camera unit 120 is arranged at a side surface of the firearm system as illustrated in FIG. 1A to photograph a fire target object.

An optical axis adjustment unit 150 includes a first rotation portion 130 and a second rotation portion 140, and supports the camera unit 120 to be capable of rotating around a first rotation axis Hc that is parallel to a Z axis and a second rotation axis Vc that is parallel to a Y axis. Thus, the optical axis adjustment unit 150 may adjust the optical axis of the camera unit 120 to a light beam of a light beam projection unit (not shown) on an image photographed by the camera unit 120.

The first rotation portion 130 of the optical axis adjustment unit 150 has a similar structure as that of the first rotation portion 30 of the optical axis adjustment unit 50 of FIG. 2. The first rotation portion 130 includes a first rotation plate 132 rotating around the first rotation axis Hc that is parallel to the Z axis, a support portion 131 rotatably supporting the first rotation plate 132, an angle adjustment portion 135 fixed to the support portion 131 and transferring a rotational force to the first rotation plate 132, and a stopper 138 fixing the first rotation plate 132 at a particular position. Thus, the first rotation portion 130 may rotate the camera unit 120 around the first rotation axis Hc.

The second rotation portion 140 has a structure similar to that of the first rotation portion 130, as a whole, except that the installation direction is changed to a vertical direction. The second rotation portion 140 includes a vertical support plate 141 coupled to the first rotation plate 132, a second rotation plate 142 rotatably coupled to the vertical support plate 141 to rotate around the second rotation axis Vc, and an angle adjustment portion 145 transferring a rotational force to the second rotation plate 142. Thus, the second rotation portion 140 may vertically rotate the camera unit 120.

Although it is not illustrated, similarly as illustrated in FIG. 5, a second gear surface may be provided on a circumferential surface of the second rotation plate 142 while a second worm gear rotating by being engaged with the second gear surface may be provided on a surface of a shaft (not shown) of the angle adjustment portion 145.

In the above-described firearm system, since the optical axis adjustment mechanism unit rotatably supports the camera unit 120 so that the camera unit 120 may be rotated around the first and second rotation axes Hc and Vc, the optical axis of the camera unit 120 may be precisely and conveniently adjusted to the light beam of the light beam projection unit on an image photographed by the camera unit 120.

In the optical axis adjustment unit 50 of FIG. 2, the structures of the first and second rotation portions 30 and 40 are different from each other, and, in the optical axis adjustment unit 150 of FIG. 9, the structures of the first and second rotation portions 130 and 140 are different from each other. However, the present invention is not limited thereto. That is, in the optical axis adjustment unit 50, the second rotation portion 40 may be applied to both of the first rotation portion rotating the camera unit around the first rotation axis Hc and the second rotation portion rotating the camera unit around the second rotation axis Vc. This modification is possible because there is no need to secure a very large rotation range of the camera unit realized by the first and second rotation portions. Also, the structure of the second rotation portion 40 of FIG. 2 may be applied to the first rotation portion only while the structure of the first rotation portion 30 of FIG. 2 may be applied to the second rotation portion.

As described above, according to the firearm system having a camera unit with an adjustable optical axis according to the exemplary embodiments of the present invention, since the optical axis adjustment unit supports the camera unit to be capable of rotating with the first and second rotation axes, the optical axis adjustment unit is conveniently manipulated so that the optical axis of the camera unit may be conveniently and precisely adjusted with respect to a light beam projected by a light tray projection unit.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A firearm system comprising:
a firing device comprising a muzzle and a light beam projection unit adjusted to an axis of the muzzle and projecting a light beam;
a camera unit arranged at a side of the firing device; and
an optical axis adjustment unit that supports the camera unit and rotates the camera unit around at least one of a first rotation axis and a second rotation axis crossing the first rotation axis to adjust an optical axis of the camera unit to the light beam of the light beam projection unit on an image obtained by the camera unit.

2. The firearm system of claim 1, wherein the optical axis adjustment mechanism comprises:
a first rotation portion comprising a first worm gear and a first rotation plate, the first rotation plate comprising a first gear surface formed on a circumferential surface thereof and coupled to the first worm gear and rotating around the first rotation axis; and
a second rotation portion installed on the first rotation plate to rotate around the second rotation axis and supporting the camera unit.

3. The firearm system of claim 2, further comprising:
a first motor coupled to the first rotation portion and generating a driving force to rotate the first rotation plate the around the first rotation axis; and
a second motor coupled to the second rotation portion and generating a driving force to rotate the second rotation portion around the second rotation axis.

4. The firearm system of claim 3, further comprising a controller connected to the camera unit, the first motor, and the second motor,
wherein the controller recognizes a position of the light beam projected by the light beam projection unit on the image obtained by the camera unit, and generates a control signal controlling the first motor and the second motor to adjust the optical axis of the camera unit to a position of the light beam.

5. The firearm system of claim 2, further comprising a stopper limiting the rotation of the camera unit by the first rotation portion and the second rotation portion.

6. The firearm system of claim 2, wherein the second rotation portion comprises:
a bottom plate coupled to the first rotation plate and comprising a concave circular arc surface formed on a surface opposite to the first rotation plate;
a movable plate comprising one surface contacting the bottom plate, on which a convex circular arc surface is formed corresponding to the concave circular arc surface of the bottom plate, and the other surface being coupled to the camera unit; and
a second worm gear coupled to a second gear surface that is formed on the convex circular arc surface of the movable plate,
wherein, when the second worm gear rotates, the movable plate is rotated along the concave circular arc surface of the bottom plate.

7. The firearm system of claim 2, wherein the second rotation portion comprises:
a vertical support plate coupled to the first rotation plate;
a second rotation plate rotatably coupled to the vertical support plate to rotate around the second rotation axis, and comprising a second gear surface formed on a circumferential surface thereof; and
a second worm gear rotating by being engaged with the second gear surface of the second rotation plate.

8. The firearm system of claim 1, wherein the optical axis adjustment unit comprises:
a first rotation portion comprising a first bottom plate comprising a first concave circular arc surface on a surface thereof, a first movable plate having a first convex circular arc surface corresponding to the first concave circular arc surface, coupled to the first bottom plate, and rotating around the first rotation axis, and a first worm gear coupled to a first gear surface formed on the first convex circular arc surface; and
a second rotation portion installed on the first movable plate to rotate around the second rotation axis and supporting the camera unit.

9. The firearm system of claim 8, wherein the second rotation portion comprises:
a second bottom plate coupled to the first movable plate and comprising a second concave circular arc surface formed on a surface opposite to the first movable plate;
a second movable plate comprising one surface contacting the second bottom plate, on which a second convex circular arc surface is formed corresponding to the concave circular arc surface of the second bottom plate, and the other surface coupled to the camera unit; and
a second worm gear coupled to a second gear surface that is formed on the second convex circular arc surface,
wherein, when the second worm gear rotates, the second movable plate is rotated along the second concave circular arc surface of the second bottom plate.

10. The firearm system of claim 8, wherein the second rotation portion comprises:
a vertical support plate coupled to the first rotation plate;
a rotation plate rotatably coupled to the vertical support plate to rotate around the second rotation axis, and comprising a second gear surface formed on a circumferential surface thereof; and
a second worm gear rotating by being engaged with the second gear surface of the rotation plate.
